(19) United States
(12) Patent Application Publication
(10) Pub. No.: US 2021/0070129 A1
(43) Pub. Date: Mar. 11, 2021

(54) SHOCK ABSORBER

(71) Applicant: DRiV Automotive Inc., Lake Forest, IL (US)

(72) Inventor: Daniel Keil, Temprance, MI (US)

(21) Appl. No.: 16/561,611

(22) Filed: Sep. 5, 2019

(51) Int. Cl. B60G 17/06

(52) U.S. Cl. CPC B60G 17/06; B60G 2400/91; B60G 2600/0422

(57) ABSTRACT

A frequency sensing system for a vehicle includes a shock absorber. The shock absorber has a frequency sensor configured to generate signals indicative of a shock frequency. The frequency sensing system includes a transmitter. The frequency sensing system includes an output device. The output device has a receiver for receiving the signals indicative of a shock frequency from the transmitter. One of the shock absorber and the output device is configured to compare the signals indicative of a shock frequency with a target frequency range. Further, the output device displays a notification when the shock frequency is outside of the target frequency range.

### TECHNICAL FIELD

The present disclosure generally relates to shock absorbers. More particularly, the present disclosure relates to a frequency sensing system for a shock absorber.

### BACKGROUND

Vehicles generally include shock absorbers that are used in conjunction with suspension systems to absorb unwanted vibrations which occur while driving the vehicle. In order to absorb the vibrations, shock absorbers are generally connected between a body of the vehicle and the suspension system. Over a period of time, shock absorbers can lose their effectiveness, thereby impacting their damping characteristics. For example, when a damping force of the shock absorber reduces, a motion of the vehicle changes towards an undamped or vibratory motion. This undamped motion may cause damage to the suspension system, tires, and may also cause discomfort to a person seated in the vehicle.

When shock absorbers wear out or operate in a defective manner, it is advisable to either replace them with a new shock absorber or service them for improved vehicle performance. Shock absorbers are generally serviced periodically, however, in some cases, the shock absorbers may require servicing or replacement between two servicing schedules. Further, as the shock absorbers get older, some frequencies and/or vibrations can be disturbing to driver comfort or experience. Thus, it is may be advantageous to have a system that identifies such disturbing frequencies and/or vibrations that may be present during operation of the vehicle and generate an alert if the shock absorber needs servicing or replacement.

Given description covers one or more above mentioned problems and discloses a system to solve the problems.

### SUMMARY

In an aspect of the present disclosure, a frequency sensing system for a vehicle is provided. The frequency sensing system includes a shock absorber. The shock absorber has a frequency sensor configured to generate signals indicative of a shock frequency. The frequency sensing system includes a transmitter. The frequency sensing system includes an output device. The output device has a receiver for receiving the signals indicative of a shock frequency from the transmitter. One of the shock absorber and the output device is configured to compare the signals indicative of a shock frequency with a target frequency range. Further, the output device displays a notification when the shock frequency is outside of the target frequency range.

In some embodiments, the transmitter comprises a wireless transmitter.

In some embodiments, the shock frequency is a wheel frequency.

In some embodiments, the shock frequency is a body frequency.

In some embodiments, the output device displays the notification only after the shock frequency remains outside of the target frequency range for a predetermined amount of time.

In some embodiments, the frequency sensing system is configured to adjust at least one operational parameter of the vehicle to reduce occurrence of the shock frequency outside of the target shock frequency range if the shock frequency is outside of the target shock frequency range.

In some embodiments, the notification includes a recommendation to service the shock absorber.

In some embodiments, the notification includes a recommendation to replace the shock absorber.

Other features and aspects of this disclosure will be apparent from the following description and the accompanying drawings.

### BRIEF DESCRIPTION OF DRAWINGS

FIG. 1 is an illustration of a vehicle incorporating a suspension system, according to an aspect of the present disclosure;

FIG. 2 is a perspective view of a shock absorber associated with the suspension system of FIG. 1, according to an aspect of the present disclosure; and

FIG. 3 is a schematic view of monitoring system for the shock absorber of FIG. 2, according to an aspect of the present disclosure.

### DETAILED DESCRIPTION

Wherever possible, the same reference numbers will be used throughout the drawings to refer to same or like parts.

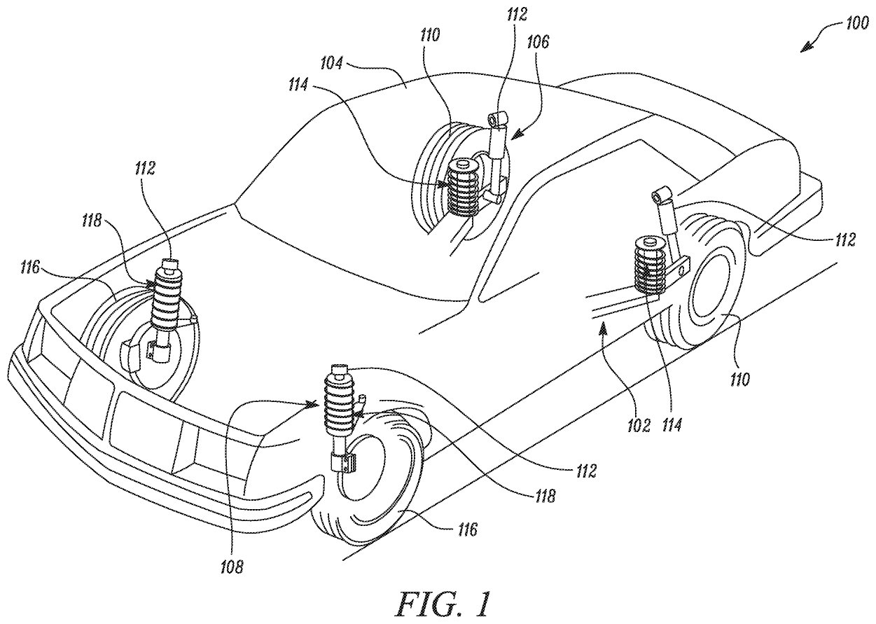

FIG. 1 illustrates an exemplary vehicle 100 incorporating a suspension system 102 in accordance with the present disclosure. The vehicle 100 may include a vehicle driven by an internal combustion engine, an electric vehicle, or a hybrid vehicle. The vehicle 100 includes a body 104. The suspension system 102 of the vehicle 100 includes a rear suspension 106 and a front suspension 108. The rear suspension 106 includes a transversely extending rear axle assembly (not shown) adapted to operatively support a pair of rear wheels 110. The rear axle assembly is operatively connected to the body 104 by means of a pair of shock absorbers 112 and a pair of helical coil springs 114. Similarly, the front suspension 108 includes a transversely extending front axle assembly (not shown) which operatively supports a pair of front wheels 116. The front axle assembly is operatively connected to the body 104 by means of another pair of the shock absorbers 112 and a pair of helical coil springs 118. In an alternative embodiment, the vehicle 100 may include an independent suspension unit (not shown) for each of the four corners instead of front and rear axle assemblies.

The shock absorbers 112 of the suspension system 102 serve to damp the relative movement of the unsprung portion (i.e., the front and rear suspensions 108, 106) and the sprung portion (i.e., the body 104) of the vehicle 100. While the vehicle 100 has been depicted as a passenger car, the shock absorbers 112 may be used with other types of vehicles. Examples of such vehicles include buses, trucks, off-road vehicles, and so forth. Furthermore, the term “shock absorber 112” as used herein will refer to dampers in general and will include McPherson struts and semi-active and active suspensions.

In some embodiments, a damping characteristic of each of the shock absorbers 112 is adjustable. In order to automatically adjust each of the shock absorbers 112, a control module (not shown) may be electrically connected to the shock absorbers 112. The control module may control an operation of each of the shock absorbers 112 in order to provide appropriate damping characteristics resulting from movements of the body 104 of the vehicle 100. Further, the control module may independently control each of the shock absorbers 112 in order to independently control a damping level of each of the shock absorbers 112. The control module may be electrically connected to the shock absorbers 112 via wired connections, wireless connections, or a combination thereof.

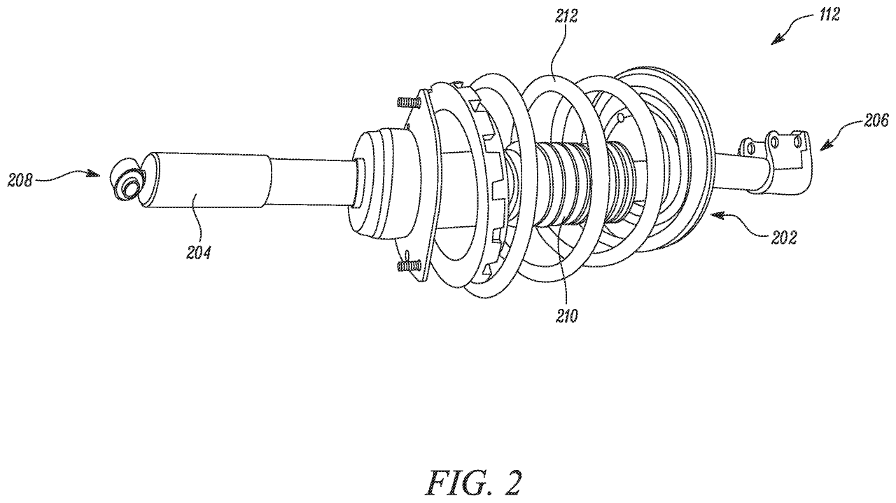

FIG. 2 illustrates a perspective view of the shock absorber 112, according to one embodiment of the present disclosure. The shock absorber 112 may be any of the four shock absorbers 112 of the vehicle 100. The shock absorbers 112 may include a Continuously Variable Semi-Active Suspension system (CVSA) shock absorber, without any limitations. A piston rod 204 of the shock absorber 112 is coupled with the body 104 (see FIG. 1) of the vehicle 100 and a shock absorber body 202 is coupled with the suspension system 102 (see FIG. 1). Further, the shock absorber 112 includes a first mounting arrangement 206 to connect the shock absorber body 202 with the suspension system 102. In one example, the first mounting arrangement 206 may include mechanical fasteners, such as bolts, screws, etc., that connect the shock absorber body 202 with the suspension system 102. Alternatively, the shock absorbers 112 may be mounted in an upside-down configuration, such as in high speed vehicles. More particularly, the shock absorber body 202 may be coupled with the body 104 and the piston rod 204 may be coupled with the suspension system 102. Additionally, a coil spring 212 is disposed around the shock absorber 112 to further isolate the body 104 from the suspension system 102.

The shock absorber 112 may contain a fluid which can be a hydraulic fluid or oil. The shock absorber 112 includes an outer tube (not shown) and an inner tube (not shown). The outer and inner tubes form a part of the shock absorber body 202. A piston (not shown) is slidably disposed within the inner tube. The shock absorber 112 also includes the piston rod 204. One end of the piston rod 204 is connected to the piston and reciprocates with the piston whereas another end of the piston rod 204 is connected to the body 104 of the vehicle 100. The piston rod 204 may be connected to the body 104 using a second mounting arrangement 208. The second mounting arrangement 208 may connect the piston rod 204 with the body 104 using mechanical fasteners, such as bolts, screws, etc. The shock absorber 112 also includes a dust tube 210. The dust tube 210 is a flexible tube having bellows such that the dust tube 210 can deform with the reciprocation of the piston rod 204. The dust tube 210 protects the piston rod 204 from dust, sand, water, or other contaminants.

The vehicle 100 is typically subjected to vibrations during operation. However, some frequency/vibrations may cause discomfort to a driver of the vehicle 100 and may affect driver comfort or experience. In some cases, such vibrations are present due to a faulty operation of the shock absorber 112, inappropriate vehicle ground clearance, or an insufficient tire pressure.

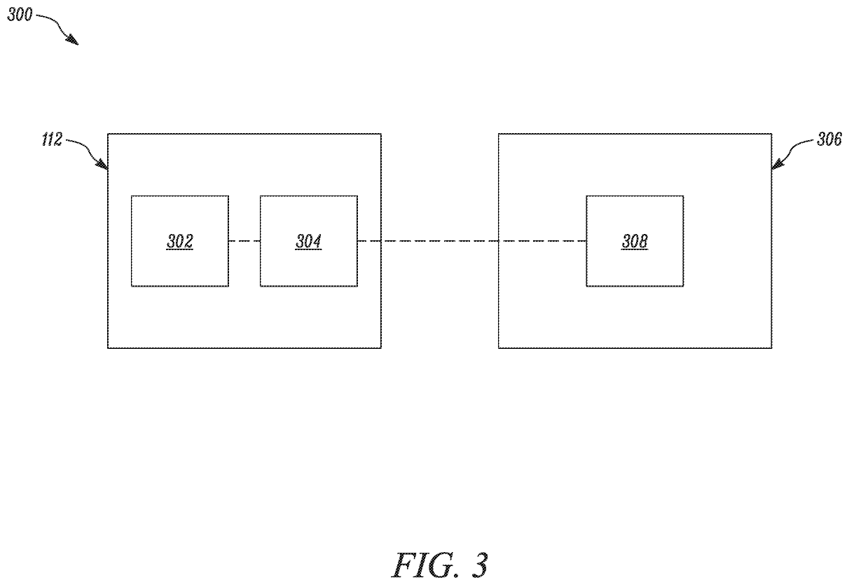

As schematically shown in FIG. 3, the present disclosure is directed towards a frequency sensing system 300 for the vehicle 100. The frequency sensing system 300 includes the shock absorber 112. The shock absorber 112 further includes a frequency sensor 302. The frequency sensor 302 may be disposed on unsprung mass such as a wheel. The frequency sensor 302 may include any one of an accelerometer, a displacement sensor, an optical sensor, a magnetic sensor, an ultrasound sensor, and the like.

The frequency sensor 302 is configured to generate signals indicative of a shock frequency of the shock absorber 112. In an embodiment, the shock frequency is a wheel frequency. In another embodiment, the shock frequency is a body frequency. The shock frequency may be measured through any other relevant component as well which may fit to description of various aspects of the present disclosure.

The frequency sensing system 300 further includes a transmitter 304 associated with the frequency sensor 302. The transmitter 304 may transmit the signals generated by the frequency sensor 302. In an embodiment, the transmitter 304 comprises a wireless transmitter. The transmitter 304 may be any other type of a transmitter as well, and the present disclosure is not limited by any particular type of the transmitter 304.

The frequency sensing system 300 includes an output device 306. The output device 306 includes a receiver 308 for receiving signals generated by the transmitter 304. At least one of the shock absorber 112 and the output device 306 is configured to compare the signals indicative of the shock frequency with a target frequency range. In case the shock absorber 112 is configured to compare the shock frequency and the target frequency range, the shock absorber 112 includes appropriate hardware required to perform the comparison. Similarly, in case the output device 306 is configured to compare the shock frequency and the target frequency range, the output device 306 includes appropriate hardware required to perform the comparison.

The term “target shock frequency range” referred to herein may be defined as an allowable frequency range that includes frequency values at which the shock absorber 112 may oscillate or vibrate without causing excessive vibrations and driver discomfort. The target frequency range may be defined based on various structural and operational parameters of the shock absorber 112 as well as the vehicle 100. Some examples may include, but not limited to, vehicle weight, ride height, application area, type of the shock absorber 112 etc.

In an embodiment, the target frequency range may be defined between a minimum acceptable frequency and a maximum acceptable frequency. The comparison of the shock frequency with the target frequency range may include comparing the shock frequency with the minimum acceptable frequency and the maximum acceptable frequency and determining whether the shock frequency lies within the target frequency range.

The output device 306 is further configured to display a notification when the shock frequency is outside of the target frequency range. If the comparison is performed by the output device 306, the output device 306 itself has result of the comparison. Further, in case the shock absorber 112 performs the comparison, information corresponding to comparison result is conveyed from the shock absorber 112 to the output device 306 through the transmitter 304 and the receiver 308.

The notification may be an audio alert, a visual alert, a text notification, a vibration or a buzzer, displaying a text message, a voice message, or by any other indicating means or any other such feedback which may notify a responsible personnel or system. In an embodiment, the output device 306 may display the notification instantly after the shock frequency is outside of the target frequency range. In another embodiment, the output device 306 may display the notification after the shock frequency remains outside of the target frequency range for a pre-determined period of time.

In an embodiment, the notification may include a recommendation to service the shock absorber 112. In such a case, the responsible personnel may be notified to perform the service/maintenance procedure. In another embodiment, the notification may include a recommendation to replace the shock absorber 112. In such a case, the responsible personnel may be notified to perform the replacement procedure.

Based on the notification issued by the output device 306, the frequency sensing system 300 is configured to attempt appropriate corrective actions. The frequency sensing system 300 is configured to adjust at least one operational parameter of the vehicle to reduce occurrence of the shock frequency outside of the target shock frequency range if the shock frequency is outside of the target shock frequency range. The operational parameter of the vehicle 100 disclosed herein may include any one of an operating pressure of the shock absorber 112, a stroke of the shock absorber 112, an operating fluid volume of the shock absorber 112, a vehicle ground clearance, or a tire pressure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A frequency sensing system for a vehicle comprising:
a shock absorber, the shock absorber including a frequency sensor configured to generate signals indicative of a shock frequency;
a transmitter;
an output device, the output device including a receiver for receiving the signals indicative of the shock frequency from the transmitter;
wherein one of the shock absorber and the output device is configured to compare the signals indicative of the shock frequency with a target frequency range; and
wherein the output device displays a notification when the shock frequency is outside of the target frequency range.

2. The frequency sensing system of claim 1, wherein the transmitter comprises a wireless transmitter.

3. The frequency sensing system of claim 1, wherein the shock frequency is a wheel frequency.

4. The frequency sensing system of claim 1, wherein the shock frequency is a body frequency.

5. The frequency sensing system of claim 1, wherein the output device displays the notification only after the shock frequency remains outside of the target frequency range for a predetermined amount of time.

6. The frequency sensing system of claim 1, wherein the frequency sensing system is configured to adjust at least one operational parameter of the vehicle to reduce occurrence of the shock frequency outside of the target frequency range if the shock frequency is outside of the target shock frequency range.

7. The frequency sensing system of claim 1, wherein the notification includes a recommendation to service the shock absorber.

8. The frequency sensing system of claim 1, wherein the notification includes a recommendation to replace the shock absorber.
